(19) United States
(12) Patent Application Publication
(10) Pub. No.: US 2021/0365800 A1
(43) Pub. Date: Nov. 25, 2021

(54) COMPUTING APPARATUS AND OPERATING METHOD THEREOF

(71) Applicant: SAMSUNG ELECTRONICS CO., LTD., Suwon-si (KR)

(72) Inventors: Rajasimhan BASKAR, Suwon-si (KR); Sachin dev SHARMA, Uttar Pradesh (IN)

(73) Assignee: SAMSUNG ELECTRONICS CO., LTD., Suwon-si (KR)

(21) Appl. No.: 17/325,954

(22) Filed: May 20, 2021

(30) Foreign Application Priority Data
May 20, 2020 (KR) 10-2020-0060617

(51) Int. Cl. G06N 5/02; G06F 16/901; G06F 40/30; G06Q 30/02; G06F 11/34

(52) U.S. Cl. CPC G06N 5/022; G06F 16/9024; G06Q 30/0201; G06Q 30/0204; G06F 11/3438; G06F 40/30

(57) ABSTRACT

A computing apparatus including a memory storing at least one instruction; and
at least one processor configured to execute the at least one instruction to: obtain terminal user property information based on data received from a terminal and a knowledge graph; and compare the terminal user property information with content property information to search for a potential customer.

### CROSS-REFERENCE TO RELATED APPLICATION

This application is based on and claims priority under 35 U.S.C. § 119 to Korean Patent Application No. 10-2020-0060617, filed on May 20, 2020, in the Korean Intellectual Property Office, the disclosure of which is incorporated by reference herein in its entirety.

### BACKGROUND

### 1. Field

The disclosure relates to a computing apparatus and an operating method thereof, and more particularly, to a computing apparatus which obtains terminal user property information and content property information and searches for a potential customer from the obtained terminal user property information and content property information, and an operating method of the computing apparatus.

### 2. Description of Related Art

Potential customer segmentation, which is a technique used in the field of advertisement, recommendation, etc., refers to splitting people into groups of people sharing common properties, according to various criteria. By using potential customer segmentation, marketers select suitable potential customers from among numerous people or select design products and services that satisfy potential customer groups. Based on the selections, the marketers may advertise the designed products and services to potential customers.

Platform operators having information about customers establish categories for segmenting potential customers. However, a marketer often fails to satisfactorily search for a potential customer having a sought property because a platform operator uniformly sets a category. Moreover, a platform does not consider a similar or related field, thus having an insufficient function of providing potential customers in similar fields.

### SUMMARY

Provided is a computing apparatus which obtains terminal user property information from data received from a terminal and an operating method of the computing apparatus.

Provided also is a computing apparatus which obtains terminal user property information by using at least one of a user knowledge graph (UKG), a contents knowledge graph (CKG), or a device graph, and an operating method of the computing apparatus.

Provided also is a computing apparatus which obtains content property information by using a CKG, and an operating method of the computing apparatus.

Provided also a computing apparatus which searches for a potential customer in detail and clearly by using terminal user property information and content property information, and an operating method of the computing apparatus.

According to an aspect of the disclosure, a computing apparatus may include a memory storing at least one instruction; and at least one processor configured to execute the at least one instruction to: obtain terminal user property information based on data received from a terminal and a knowledge graph; and compare the terminal user property information with content property information to search for a potential customer.

The at least one processor may be further configured to obtain the content property information by adding information semantically related to content to metadata regarding the content by using a content knowledge graph (CKG).

The at least one processor may be further configured to compare the terminal user property information with first content property information in response to a potential customer search request related to a first content to search for a potential customer related to the first content.

The data received from the terminal may include at least one of terminal identification information, terminal use history information, consumed-content information, or information about at least one electronic device connected to the terminal.

The terminal use history information may include at least one of a use frequency, a use duration, a use time, or a use day of the terminal, and the consumed-content information comprises at least one of identification information of content consumed using the terminal or consumption type information of the consumed content.

The information about the at least one electronic device connected to the terminal comprises at least one of device identification information, device use history information, or device use pattern information. The at least one processor may be further configured to obtain a device graph based on the information about the at least one electronic device.

The knowledge graph may include at least one of a user knowledge graph (UKG) or a content knowledge graph (CKG). The at least one processor may be further configured to obtain the terminal user property information based on the data received from the terminal, the device graph, and the knowledge graph.

The at least one processor may be further configured to: obtain at least one of demographic information, geographical position information, use time information, a terminal use tendency, a viewing tendency, or behavior information of a terminal user; and obtain the terminal user property information from the obtained at least one of the demographic information, the geographical position information, the use time information, the terminal use tendency, the viewing tendency, or the behavior information of the terminal user.

The at least one processor may be further configured to, by using the CKG, obtain the terminal user property information by adding information semantically related to content consumed using the terminal to metadata regarding the consumed content.

The at least one processor may be further configured to reinforce the terminal user property information by using the device graph.

According to another aspect of the disclosure, an operating method of a computing apparatus may include obtaining terminal user property information based on data received from a terminal and a knowledge graph; obtaining content property information; and comparing the terminal user property information with content property information to search for a potential customer.

The obtaining of the content property information may include obtaining the content property information by adding information semantically related to content to metadata regarding the content by using a content knowledge graph (CKG).

The searching for the potential customer may include comparing the terminal user property information with first content property information in response to a potential customer search request related to a first content to search for a potential customer related to the first content.

The data received from the terminal may include at least one of terminal identification information, terminal use history information, consumed-content information, or information about at least one electronic device connected to the terminal.

The terminal use history information may include at least one of a use frequency, a use duration, a use time, or a use day of the terminal, and the consumed-content information may include at least one of identification information of content consumed using the terminal or consumption type information of the consumed content.

The information about the at least one electronic device connected to the terminal may include at least one of device identification information, device use history information, or device use pattern information. The operating method may further include obtaining a device graph based on the information about the at least one electronic device.

The knowledge graph may include at least one of a user knowledge graph (UKG) or a content knowledge graph (CKG). The obtaining of the terminal user property information may include obtaining the terminal user property information based on the data received from the terminal, the device graph, and the knowledge graph.

The obtaining of the terminal user property information may include obtaining at least one of demographic information, geographical position information, use time information, a terminal use tendency, a viewing tendency, or behavior information of a terminal user; and obtaining the terminal user property information from the obtained at least one of the demographic information, the geographical position information, the use time information, the terminal use tendency, the viewing tendency, or the behavior information of the terminal user.

The obtaining of the terminal user property information comprises obtaining, by using the CKG, the terminal user property information by adding information semantically related to content consumed using the terminal to metadata regarding the consumed content.

According to another aspect of the disclosure, a non-transitory computer-readable recording medium having recorded thereon a program for executing an operating method of a computing apparatus. The operating method may include obtaining terminal user property information based on data received from a terminal and a knowledge graph; obtaining content property information; and comparing the terminal user property information with content property information to search for a potential customer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing a process of providing a potential customer by a computing apparatus according to an embodiment;

FIG. 2 is a diagram of a knowledge graph according to an embodiment;

FIG. 3 is a diagram of a device graph according to an embodiment;

FIG. 4 is a diagram showing reinforcement of content property information by using a content knowledge graph (CKG) according to an embodiment;

FIG. 5 shows a user interface to which an extended query is inputtable according to an embodiment;

FIG. 6 is a block diagram of a computing apparatus according to an embodiment;

FIG. 7 is a block diagram of a processor of FIG. 6 according to an embodiment; and

FIG. 8 is a flowchart of an operating method of a computing apparatus, according to an embodiment.

### DETAILED DESCRIPTION

Hereinafter, example embodiments of the disclosure will be described in detail with reference to the attached drawings to allow those of ordinary skill in the art to easily carry out the embodiments of the disclosure. However, the disclosure may be implemented in various forms, and are not limited to the example embodiments of the disclosure described herein.

Although terms used in the disclosure are selected with general terms popularly used at present under the consideration of functions in the disclosure, the terms may vary according to the intention of those of ordinary skill in the art, judicial precedents, or introduction of new technology. Thus, the terms used in the disclosure should be defined not by the simple names of the terms but by the meaning of the terms and the contents throughout the disclosure.

The terms used in the disclosure are for the purpose of describing particular exemplary embodiments of the disclosure only and are not intended to limit the disclosure.

In the description of the embodiments of the disclosure, when a part is “connected” to another part, the part is not only “directly connected” to another part but also “electrically connected” to another part with another device intervening in them.

In the present specification, especially, in the claims, the use of “the” and other demonstratives similar thereto may correspond to both a singular form and a plural form. Unless the order of operations of a method according to the disclosure is explicitly mentioned or described otherwise, the operations may be performed in a proper order. The disclosure is not limited by the order the operations are mentioned.

The phrase used in various parts of the present specification, such as “in some embodiments of the disclosure” or “in an embodiment of the disclosure” does not necessarily indicate the same embodiment of the disclosure.

Some embodiments of the disclosure may be represented by functional block components and various processing operations. All or some of such functional blocks may be implemented by various numbers of hardware and/or software components which perform specific functions. For example, functional blocks of the disclosure may be implemented by one or more microprocessors or circuit elements for a specific function. In addition, the functional blocks of the disclosure may also be implemented as various programming or scripting languages. The functional blocks may be implemented as an algorithm executed in one or more processors. Furthermore, the disclosure may employ any number of conventional techniques for electronics configuration, signal processing and/or control, data processing and the like. The term “mechanism”, “element”, “means”, or “component” is used broadly and is not limited to mechanical or physical components.

Connecting lines or connecting members between elements shown in the drawings are intended to merely illustrate functional connections and/or physical or circuit connections. In an actual device, connections between elements may be indicated by replaceable or added various functional connections, physical connections, or circuit connections.

The term used in the embodiments of the disclosure such as “unit” or “module” indicates a unit for processing at least one function or operation, and may be implemented in hardware, software, or in a combination of hardware and software.

Throughout the disclosure, the expression “at least one of a, b or c” indicates only a, only b, only c, both a and b, both a and c, both b and c, all of a, b, and c, or variations thereof.

Herein, the term “user” may refer to a person who controls a function or an operation of a computing apparatus or an image display apparatus by using the computing apparatus or the image display apparatus or uses the image display apparatus according to a function, and may include a viewer, a manager, or an installation engineer.

Moreover, herein, a “marketer” may refer to a person, a company, etc., that searches for customers who are interested in or are highly likely to consume products, services, etc., to be marketed, e.g., advertised or recommended, by using a computing apparatus.

Hereinafter, the disclosure will be described with reference to the accompanying drawings.

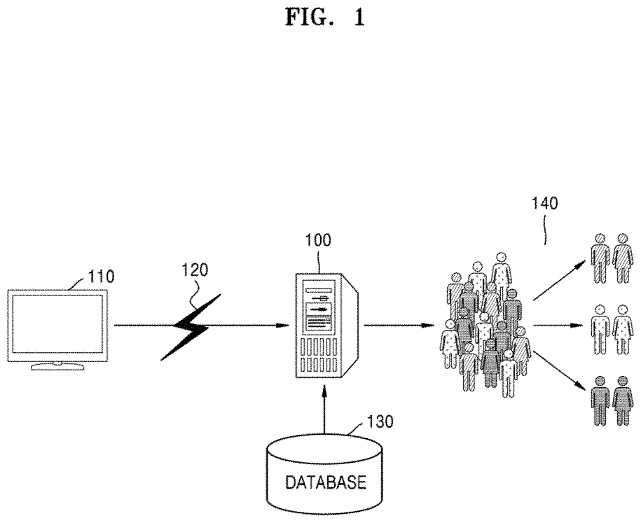

FIG. 1 is a diagram showing a process of providing a potential customer by a computing apparatus according to an embodiment.

Referring to FIG. 1, a computing apparatus 100 may be coupled with a terminal 110 through a communication network 120. The terminal 110 may be implemented as various forms of electronic devices capable of wiredly or wirelessly communicating with the computing apparatus 100.

According to an embodiment, the terminal 110 may include an image display apparatus. The image display apparatus may communicate with the computing apparatus 100 through the communication network 120 and may be implemented as various electronic devices capable of outputting images. The image display apparatus may be of a stationary/fixed type or a mobile type. For example, the image display apparatus may include at least one of a desktop, a digital television (TV), a smartphone, a tablet personal computer (PC), a mobile phone, a video phone, an electronic book (e-book) reader, a laptop PC, a netbook computer, a digital camera, a personal digital assistant (PDA), a portable multimedia player (PMP), a camcorder, a navigation system, a wearable device, a smart watch, a home network system, a security system, or a medical device.

The user may cause a function of the terminal 110 to be performed using the terminal 110 in various ways.

The terminal 110 may transmit one or more of terminal identification information, terminal use history information, and consumed-content information to the computing apparatus 100.

The terminal identification information may include, as information for identifying the terminal 110, one or more of a type, company information, a manufacturer, model information, an identification number, and an Internet protocol (IP) address of the terminal 110.

The terminal use history information may include at least one of a use frequency, a use duration, a use time, or a use day of the terminal 110 used by the user.

The consumed-content information may include, as information about content consumed by the user using the terminal 110, at least one of identification information of consumed content or a consumption type of the consumed content. The identification information of the consumed content may include, as information for identifying content consumed by the user using the terminal 110, program identification information, particular application identification information, or function identification information regarding a function executed in an application.

The consumption type may refer to a consumption type such as whether the user views a program by using the terminal 110, whether the user executes a particular application, whether the user purchases an item or program viewing, or whether the user searches for a particular program simply through browsing.

The content may include digital information provided through a wired/wireless communication network. The content may include, but is not limited to, advertisement content, video content (e.g., a TV program image, a video on-command (VoD) image, a personal image (user-created content (UCC)), music videos, YouTube videos, etc.), still-image content (e.g., a picture, a drawing, etc.), text content (e.g., an e-book (poetry, novels, etc.), letters, working files), music content (e.g., music, an instrumental song, a radio broadcasting program, etc.), a web page, application execution information, and so forth.

In addition, herein, the content may also include an application executable by using the terminal 110, information to be marketed such as a service that is providable to the user, a product available for purchase, etc.

According to an embodiment, the computing apparatus 100 may obtain terminal user property information from data received from the terminal 110. The terminal user property information may include, as information indicating properties of a terminal user, one or more of terminal user personalized information and terminal user taste information.

To this end, the computing apparatus 100 may use a knowledge graph obtained from a database 130. The knowledge graph may refer to a graph providing a result having relationships by using semantic information accumulated from various sources.

The knowledge graph may include at least one of a user knowledge graph (UKG) or a content knowledge graph (CKG). While the knowledge graph is stored in the database 130 in FIG. 1, this is merely an example, and the knowledge graph may be generated by a server and obtained from the server for use.

The computing apparatus 100 may obtain the terminal user personalized information and the terminal user taste information by using data received from the terminal 110 and a knowledge graph.

As such, according to an embodiment, the computing apparatus 100 may obtain terminal user property information by using the data received from the terminal 110 and the knowledge graph obtained from the database 130, i.e., at least one of a UKG or a CKG, thereby obtaining detailed and rich information regarding the terminal user.

According to an embodiment, the terminal 110 may transmit information about at least one electronic device connected to the terminal 110 to the computing apparatus 100. The information about the electronic device connected to the terminal 110 may include at least one of the identification information of the electronic device, the device use history information, or device use pattern information.

The computing apparatus 100 may extend terminal user property information obtained using the knowledge graph, i.e., at least one of the UKG or the CKG, by using a device graph and use the extended terminal user property information.

According to an embodiment, the computing apparatus 100 may obtain content property information by using the CKG. The content property information may refer to information that describes properties of content. The computing apparatus 100 may obtain the content property information by adding information semantically related to each content to metadata regarding the content.

The computing apparatus 100 may use electronic program guide (EPG) information, etc., of a program as the metadata regarding the content. According to an embodiment, the computing apparatus 100 may further obtain information about the properties of the content from various information providing databases or a server, etc., in addition to the EPG information, and add the obtained information to the metadata regarding the content, thereby extending the properties of the content.

According to an embodiment, the computing apparatus 100 may receive a potential customer search request related to certain content and compare terminal user property information with certain content property information accordingly in response to the received potential customer search request to search for a potential customer 140 related to the certain content. As described above, the terminal user property information and the content property information have added thereto various properties and are reinforced, using a knowledge graph, such that the computing apparatus 100 may search for a terminal user having properties related to content to be searched for by a marketer in more detail and accurately.

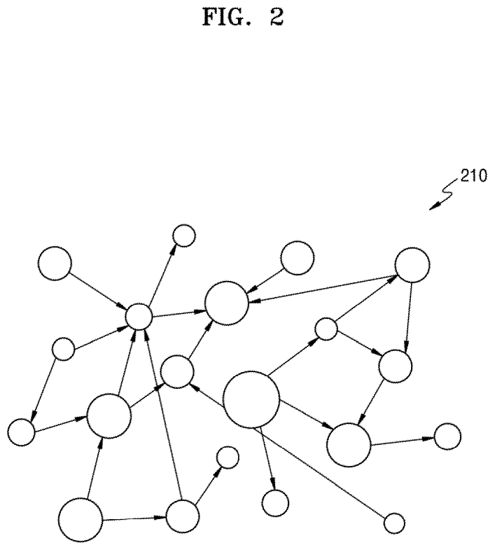

FIG. 2 is a view for describing a knowledge graph according to an embodiment.

A knowledge graph 210 is shown in FIG. 2. The knowledge graph 210 may provide a link to structured information and other information. In FIG. 2, a node may represent various themes. For example, the node may refer to content, a user, or a certain property. Related contents or users may be linked to each other.

The knowledge graph 210 may be used to improve a search result by providing information that is useful for and has relationships with a theme by using semantic information accumulated from various sources.

The database 130 or the server may store a knowledge graph generated based on big data received from various users and various devices. The big data used to generate the knowledge graph may include context information related to various contexts. The database 130 or the server may update the knowledge graph at certain intervals.

According to an embodiment, the computing apparatus 100 may use at least one of a UKG or a CKG.

The UKG may provide personalized information that is appropriate for a certain terminal user based on browsing, purchase, viewing, contextual information, demographic information, and real-time behavior data of several users and several devices, which are obtained through several sources or channels. The UKG may be used to adjust content, a product, or a service appropriately for an individual user. The UKG may include a viewing trend such as a high viewer rating program or content genre for each geographical position or each time zone. The UKG may include user profile information. The user profile information may include various types of demographic information such as user's gender, age group, nationality, language, etc.

The computing apparatus 100 may obtain personalized information of the user of the terminal 100 (or terminal user personalized information) that transmits data, by using data received from the terminal 110 and the UKG.

The computing apparatus 100 may accumulate data received from the terminal 110 for a certain period and use the data. The computing apparatus 100 may update the data received from the terminal 110 or the knowledge graph at predetermined periods or every occurrence of a predetermined event to reflect the latest trend.

The terminal user personalized information may include, for example, one or more of demographic information, geographical position information, terminal use tendency, viewing tendency, and behavior information of the terminal user. Herein, the terminal use tendency may refer to a tendency such as a tendency for the user to use a certain time or to use a VOD service using the terminal. The viewing tendency may refer to information, for example, indicating that a genre viewed by the user is a drama or news or the user views an advertisement. The behavior information may mean pattern information, for example, indicating that the user views a program on a weekend, the user executes an application on a certain day of the week, the user purchases a product after watching a certain program, or the user watches a program of a genre after watching a program of another genre.

The computing apparatus 100 may obtain user taste information of the user of the terminal 110 (or terminal user personalized information) that transmits data, by using data received from the terminal 110 and the CKG.

The computing apparatus 100 may accumulate data received from the terminal 110 for a predefined period and use the data. The computing apparatus 100 may update the data received from the terminal 110 or the knowledge graph every predefined period or upon every occurrence of a predefined event to reflect the latest trend.

The CKG may add information semantically related to content to metadata regarding the content. The metadata provided by a content metadata provider, such as an EPG, provides one-dimensional information regarding the content, whereas the CKG may extend semantically various and rich information.

Various sites or database providers such as IMDB, WiKi, etc., may provide content and detailed information about properties of the content in the form of the CKG. The CKG may provide links between various contents such as movies, programs, etc., based on a certain algorithm, by using nodes, properties, relationships, relationship types, etc.

The terminal user taste information may mean information about the field of interest of the user, which is obtained from the information semantically related to the content consumed by the user using the terminal 110. The computing apparatus 100 may improve a content use history of the user by using the CKG. For example, when the user watches the movie “Mission Impossible” by using the terminal 110, various information such as a director, actors or actresses, a genre, a shooting place, a rating, and the year of production of the movie, other movies of the director, other films in which the actors or actresses appear, etc., may be extended as user taste information.

The computing apparatus 100 may use the personalized information of the user of the terminal 110 (or terminal user personalized information) that transmits data, and the terminal user taste information, which are obtained by using data received from the terminal 100, the UKG, and the CKG, as the terminal user property information.

According to an embodiment, the computing apparatus 100 may extend property information regarding general contents by using the CKG. For example, for the movie “Magnolia”, various properties related to the movie, i.e., a director, actors or actresses, a genre, an era, etc., of the movie may be added as metadata.

Thereafter, when the marketer desires to search for a potential customer related to certain content, e.g., the movie “Magnolia”, the computing apparatus 100 may recognize that Tom Cruise acting in “Magnolia” is related to the movie “Mission Impossible”, by using content property information and terminal user property information, and find a user having a property related to Tom Cruise as a potential customer. In this case, the user watching the movie “Mission Impossible” using the terminal 110 may also be searched as a potential customer.

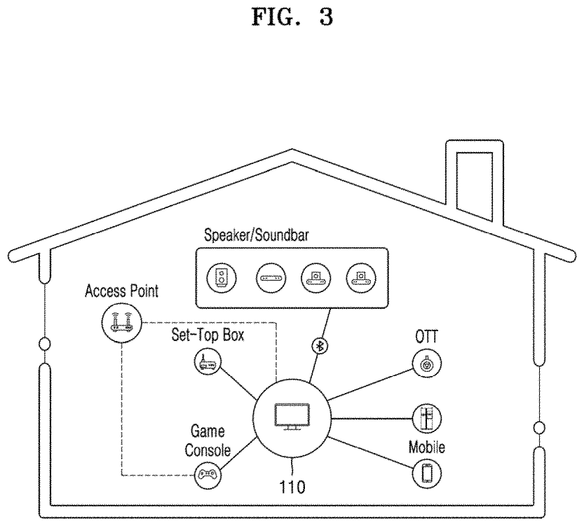

FIG. 3 is a view for describing a device graph according to an embodiment.

According to an embodiment, the terminal 110 may transmit information about at least one electronic device connected to the terminal 110 to the computing apparatus 100. The information about the electronic device connected to the terminal 110 may include at least one of the identification information of the electronic device, the device use history information, or device use pattern information.

The terminal 110 may periodically transmit log messages of various types for software, hardware, user interaction, and a connected device to the computing apparatus 100. These log messages may be processed by another computer processing system and may be converted into various data sets.

When the terminal 110 is a TV, an electronic device connected to the terminal 110 may refer to an electronic device that may be detected through various connection interfaces supported by the TV, e.g., Wireless Fidelity (WiFi), Bluetooth, a high-definition multimedia interface (HDMI), etc.

As shown in FIG. 3, the electronic device connected to the terminal 110 may include one or more of various types of electronic devices, such as a router, a refrigerator, a set-top box, a game console, a speaker, a sound bar, etc.

The computing apparatus 100 may identify an IP address of the terminal 110 and identify electronic devices connected to the terminal 110 by using a log message for a device connected to the terminal 110, which is received from the terminal 110 having the identified IP address. In this way, the computing apparatus 100 may identify electronic devices belonging to one house or household.

According to an embodiment, the computing apparatus 100 may connect the terminal 110 to an electronic device connected thereto, thus obtaining a device graph.

According to another embodiment, a separate server or a separate module other than the computing apparatus 100 may obtain information about the terminal 110 and the electronic device connected to the terminal 110 and generate a device graph from the obtained information.

The device graph may be generated by accumulatively using information about at least one electronic device connected to the terminal 110, which is received from the terminal 110 for a certain period. The device graph may be updated at predetermined periods or upon every occurrence of a predetermined event.

According to an embodiment, the computing apparatus 100 may add more information to the terminal user property information by using the device graph together with the UKG or the CKG. That is, the computing apparatus 100 may add a use pattern for another electronic device used by the user of the terminal 110, or electronic devices of family members living in the same household as the user of the terminal 110, etc., to the terminal user property information.

For example, when the terminal 110 is a high-price premium product and electronic devices connected to the terminal 110 are high-price products from the terminal identification information received from the terminal 110, the computing apparatus 100 may add information about a high-price product or high-price service to the terminal user property information.

According to another example, when the electronic devices connected to the terminal 110 are electronic devices for children such as children game consoles, children computers, etc., the computing apparatus 100 may add information about a product or a service related to parenting, a program related to parenting, etc., to the terminal user property information.

According to another example, when the terminal 110 connected to an audio system is disconnected from the audio system at a certain instant, the computing system 100 may allow a marketer of the audio system to search for the user of the terminal 110, thus providing marketing information regarding the audio system to the user of the terminal 110.

As such, according to an embodiment, the computing apparatus 100 may use the device graph obtained from the information regarding the electronic device connected to the terminal 110, together with the knowledge graph, thus reinforcing the terminal user property information.

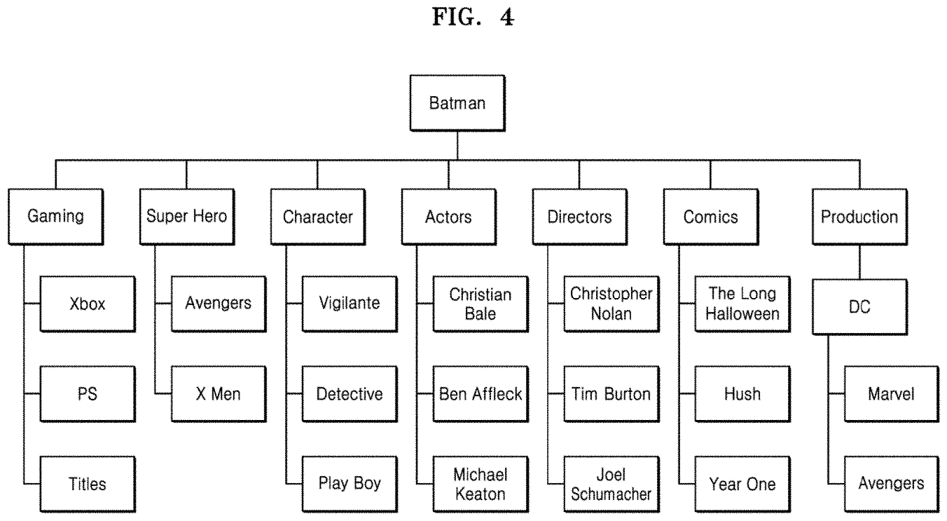

FIG. 4 is a diagram for describing reinforcement of content property information by using a CKG according to an embodiment.

The computing apparatus 100 may add information semantically related to content to metadata regarding the content, by using the CKG. That is, the computing apparatus 100 may connect the content to a group of semantically related contents by using the CKG, thus obtaining reinforced content property information.

For example, the marketer is assumed to search for a customer who likes “Batman”. When the marketer searches for “Batman” by using EPG metadata, a viewer who watches the movie “Batman” may be found.

According to an embodiment, the computing apparatus 100 may extend content property information regarding content “Batman”, by using the CKG. That is, the computing apparatus 100 may add various properties semantically related to “Batman” to metadata regarding “Batman” by using the CKG, as shown in FIG. 4. Referring to FIG. 4, for the content “Batman”, various tags such as a director, actors or actresses, characters, a genre, a superhero, a game, comics, etc., are added as property information.

When the marketer searches for “Batman”, the computing apparatus 100 may provide not only a viewer watching the movie “Batman”, but also information about customers related to surrounding regions of interest related to “Batman”, as search results. That is, the computing apparatus 100 may search for a user playing a Batman console game or reading a Batman cartoon, a user watching other movies of the director of “Batman”, a user being interested in other superheroes, and a customer who likes villain movies, by extending a potential customer to them.

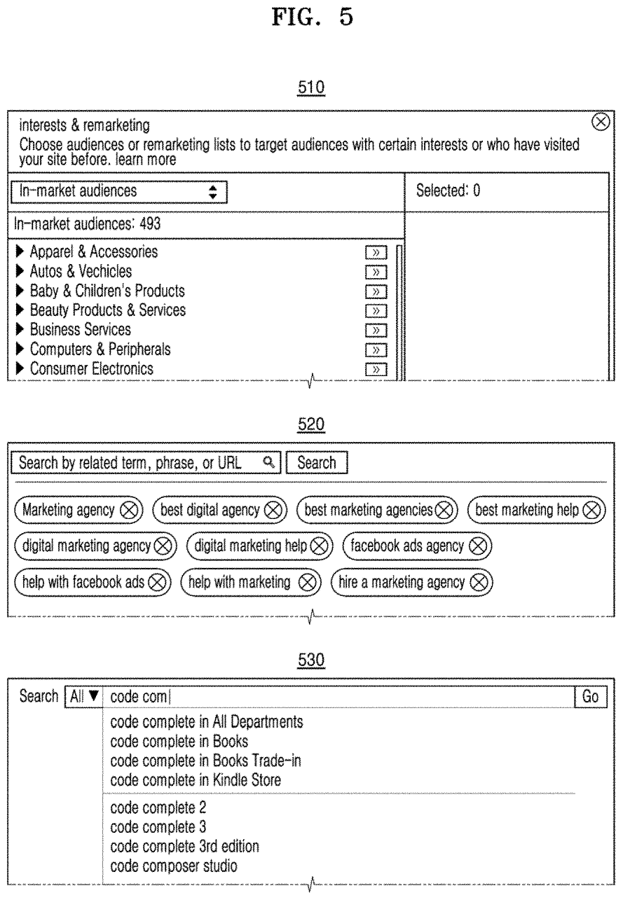

FIG. 5 shows a user interface to which an extended query is inputtable according to an embodiment.

Referring to FIG. 5, the computing apparatus 100 may extend content property information by using the CKG, and provide a user interface through which extended content property information may be searched.

The marketer, i.e., a searcher, may input an extended query to a user interface provided by the computing apparatus 100 to more accurately find a desired potential customer.

According to an embodiment, the computing apparatus 100 may enable the searcher to input an extended query in various forms as provided by a search engine to obtain a desired result.

For example, the computing apparatus 100 may output a search screen 510 as shown in FIG. 5. The searcher may select a desired category among several categories output on the search screen 510, and when the searcher selects a certain category, the computing apparatus 100 may output a screen for selecting low-level categories in the selected category. The searcher may specify the desired category by stepwisely selecting the desired category among the low-level categories, thus searching for a potential customer related to the certain category.

According to another embodiment, the computing apparatus 100 may output a search screen 520 as shown in FIG. 5. The search screen 520 may provide a search window to which the searcher inputs a desired property by directly typing the property thereto, and various categories that are selectable in relation to information input by typing of the searcher. The searcher may search for a potential customer having a certain property by directly typing the property of the potential customer or selecting the selected category among the output categories.

According to another embodiment, the computing apparatus 100 may output a search screen 530 as shown in FIG. 5. The search screen 530 may provide a search window to which the searcher inputs a desired property by directly typing the property. When the searcher types the desired property on the search window output on the search screen 530, the computing apparatus 100 may automatically output a search word related to the typed information to enable the searcher to easily type the desired property.

As such, according to an embodiment, the searcher may search for a desired potential customer in detail and accurately by extending a search to a low-level category as well as to a high-level category.

According to an embodiment, the computing apparatus 100 or the searcher may control a connection level by adjusting a depth (or level) of content. That is, the computing apparatus 100 or the searcher may adjust the accuracy of the potential customer by setting a low level of a search category. For example, the computing apparatus 100 or the searcher may set the low level of the search category to three steps or six steps to adjust the accuracy of the potential customer.

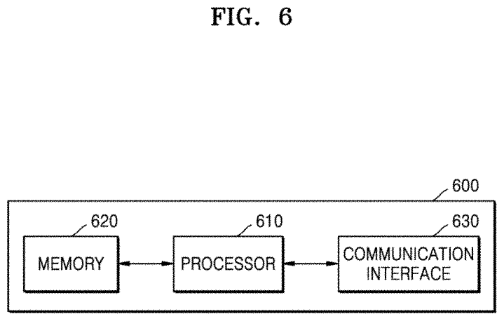

FIG. 6 is an block diagram of a computing apparatus 600 according to an embodiment.

Referring to FIG. 6, the computing apparatus 600 may include a processor 610, a memory 620, and a communication interface 630.

The computing apparatus 600 may be implemented as various electronic devices capable of searching for a potential customer by obtaining terminal user property information from data received from the terminal, obtaining content property information, and comparing the terminal user property information with the content property information.

According to an embodiment, the computing apparatus 600 may be manufactured in the form of at least one hardware chip and may be mounted on an electronic device or may be included in a server in the form of a chip or an electronic device. Alternatively, the computing apparatus 600 may be included in an image display apparatus. Alternatively, the computing apparatus 600 may be implemented as a software module.

According to an embodiment, the communication interface 630 may communicate with external devices via a wired/wireless network. More specifically, the communication interface 630 may transmit and receive a signal to and from an external device connected through a wired/wireless network under control of the processor 610. The external device may include a server, a server system, a server-based device, etc., which processes data transmitted to or received from the communication interface 630.

According to an embodiment, the external device may be a terminal such as an image display apparatus. The external device may be a database or a server that stores a knowledge graph.

The communication interface 630 may include at least one communication module such as a short-range communication module, a wireless communication module, a mobile communication module, a broadcasting reception module, etc. Herein, the communication module may include a tuner that performs broadcasting reception or a communication module capable of performing data transmission/reception through a network complying with communication standards such as Bluetooth, wireless local area network (WLAN), Wireless Fidelity (WiFi), Wireless Broadband (WiBro), World Interoperability for Microwave Access (WiMax), code divisional multiple access (CDMA), wideband CDMA (WCDMA), etc.

The communication interface 630 may receive data from the terminal. The communication interface 630 may receive at least one of terminal identification information, terminal use history information, consumed-content information, or information about at least one electronic device connected to the terminal.

The terminal use history information may include at least one of a use frequency, a use duration, a use time, or a use day of the terminal used by the user, and the consumed-content information may include at least one of identification information of content consumed using the terminal or a consumption type of the consumed content. The information about the at least one electronic device connected to the terminal may include at least one of device identification information of the electronic device, the device use history information, or the device use pattern information.

The memory 620 according to an embodiment may store at least one instruction. The memory 620 may store at least one program to be executed by the processor 610. The memory 620 may store data input to the computing apparatus 600 or data output from the computing apparatus 600.

The memory 310 may include a storage medium of at least one type of a flash memory type, a hard disk type, a multimedia card micro type, a card type memory (e.g., a secure digital (SD) or extreme digital (XD) memory, etc.), a random-access memory (RAM), a static random-access memory (SRAM), a read-only memory (ROM), an electrically erasable programmable read-only memory (EEPROM), a programmable read-only memory (PROM), a magnetic memory, a magnetic disk, an optical disk, or the like.

The processor 610 may generally control an overall operation of the computing apparatus 600. The processor 610 may control the computing apparatus 600 to function, by executing one or more instructions stored in the memory 620.

The processor 610 may obtain information about at least one electronic device connected to the terminal from the terminal and obtain a device graph from the obtained information. The processor 610 may obtain terminal user property information by using at least one of a knowledge graph such as a UKG or a CKG obtained through the communication interface 630 or the device graph.

The processor 610 may obtain the content property information by adding information related to content to metadata regarding the content using the CKG.

When the processor 610 receives a potential customer search request related to certain content, the processor 610 may compare the terminal user property information with the certain content property information accordingly in response to the received potential customer search request to search for a potential customer related to the certain content.

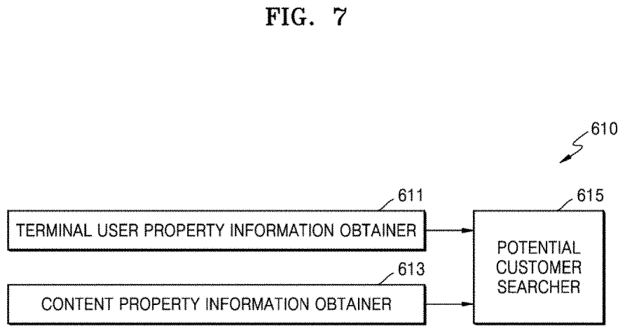

FIG. 7 is an block diagram of the processor 610 of FIG. 6 according to an embodiment.

Referring to FIG. 7, the processor 610 may include a terminal user property information obtainer 611, a content property information obtainer 613, and a potential customer searcher 615.

The terminal user property information obtainer 611 may use a UKG obtained from the database or the server. The UKG may provide information appropriate for a certain terminal user based on information about several users and several devices.

The terminal user property information obtainer 611 may obtain terminal user personalized information by using the UKG. The terminal user personalized information may include one or more of demographic information, geographical position information, terminal use tendency, viewing tendency, and behavior information of the terminal user.

The terminal user property information obtainer 611 may obtain terminal user taste information by adding information semantically related to content consumed using the terminal to metadata regarding the content consumed using the terminal, by using the CKG obtained from the database, the server, etc.

The terminal user property information obtainer 611 may obtain user property information including the terminal user personalized information and the terminal user taste information.

Although not shown in FIG. 7, the processor 610 may further include a device graph obtainer. The processor 610 may obtain a device graph by using information about an electronic device connected to the terminal from the terminal. Alternatively, the processor 610 may obtain the device graph generated from an external device, etc., and use the obtained device graph. The processor 610 may reinforce the terminal user property information by using the device graph.

The content property information obtainer 613 may obtain a CKG from the database, the server, etc. The content property information obtainer 613 may obtain the content property information by adding information related to each of general contents to metadata regarding each content, by using the CKG.

The potential customer searcher 615 may search for a potential customer by using the database terminal user property information received from the terminal user property information obtainer 611 and the content property information received from the content property information obtainer 613. When the potential customer searcher 615 receives a potential customer search request related to certain content, the potential customer searcher 615 may compare the terminal user property information with the certain content property information accordingly in response to the received potential customer search request to search for a potential customer related to the certain content.

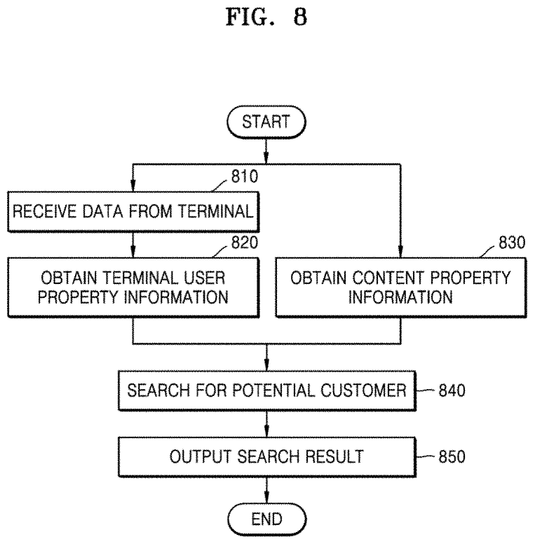

FIG. 8 is a flowchart of an operating method of a computing apparatus, according to an embodiment.

Referring to FIG. 8, the computing apparatus may receive data from the terminal in operation 810. The computing apparatus may receive at least one of terminal identification information, terminal use history information, consumed-content information, or information about at least one electronic device connected to the terminal.

The computing apparatus may generate a device graph from another electronic device information received from the terminal or obtain the device graph from the external device.

The computing apparatus may obtain the terminal user property information from the data received from the terminal in operation 820. The terminal user property information may include one or more of the terminal user personalized information and the terminal user taste information, and may describe the property of the terminal user.

The computing apparatus may obtain the terminal user property information by using at least one of the UKG, the CKG, or the device graph.

The computing apparatus may obtain the content property information by adding information related to content information to metadata regarding the content, by using the CKG, in operation 830.

When the computing apparatus receives a potential customer request, the computing apparatus may search for a potential customer by comparing the terminal user property information with the content property information, in operation 840. The computing apparatus may search for a terminal user related to certain content among a plurality of terminal users, as a potential customer, by comparing several properties of the terminal user, included in the terminal user property information, with several properties of the content, included in the content property information.

The computing apparatus may output a search result in operation 850.

The computing apparatus and the operating method thereof according to some embodiments may be implemented with a recording medium including a computer-executable instruction such as a computer-executable programming module. A computer-readable recording medium may be an available medium that is accessible by a computer, and includes all of a volatile medium, a non-volatile medium, a separated medium, and a non-separated medium. The computer-readable recording medium may also include both a computer storage medium and a communication medium. The computer storage medium includes all of a volatile medium, a non-volatile medium, a separated medium, and a non-separated medium, which is implemented by a method or technique for storing information such as a computer-readable instruction, a data structure, a programming module, or other data. The communication medium includes a computer-readable instruction, a data structure, a programming module, or other data of a modulated data signal like carriers, or other transmission mechanisms, and includes an information delivery medium.

In the specification, the term “unit” may be a hardware component like a processor or a circuit, and/or a software component executed by a hardware component like a processor.

The operating method of the computing apparatus according to the above-described embodiments may be implemented as a computer program product including a recording medium having recorded thereon a computer program for executing the operating method of the computing apparatus, the operating method including obtaining terminal user property information from data received from a terminal and a knowledge graph, obtaining content property information, and searching for a potential customer by comparing terminal user property information with content property information.

The operating method of the computing apparatus according to an embodiment may use an artificial intelligence (AI) model. The computing apparatus according to an embodiment or a processor included in the computing apparatus may perform preprocessing on data to convert the data into a form that is appropriate for use as an input to the AI model. The AI model may be made through training. Herein, when the AI model is made through training, it may mean that a basic AI model is trained based on a learning algorithm by using various training data, such that the predefined operation rule or AI model set to execute desired characteristics (or purpose) is made. The AI model may include a plurality of neural network layers. Each of the plurality of neural network layers may have a plurality of weight values, and perform a neural network operation through an operation between an operation result of a previous layer and the plurality of weight values.

Reasoning/prediction may refer to technology for determining information and executing logical reasoning and prediction and include knowledge/probability-based reasoning, optimization prediction, preference-based planning, recommendation, etc.

The computing apparatus and the operating method thereof according to an embodiment may obtain the device graph from the data received from the terminal.

The computing apparatus and the operating method thereof according to an embodiment may obtain the terminal user property information by using at least one of the UKG, the CKG, or the device graph.

The computing apparatus and the operating method thereof according to an embodiment may obtain the content property information by using the CKG.

The computing apparatus and the operating method thereof according to an embodiment may search for a potential customer in detail and clearly by using the terminal user property information and the content property information.

Those of ordinary skill in the art to which the disclosure pertains will appreciate that the disclosure may be implemented in different detailed ways without departing from the technical spirit or essential characteristics of the disclosure. Thus, it should be noted that the above-described embodiments of the disclosure are provided as examples and should not be interpreted as limiting. For example, each element described as a single type may be implemented in a distributed manner, and likewise, elements described as being distributed may be implemented as a coupled type.

What is claimed is:

1. A computing apparatus comprising:
a memory storing at least one instruction; and
at least one processor configured to execute the at least one instruction to:
obtain terminal user property information based on data received from a terminal and a knowledge graph; and
compare the terminal user property information with content property information to search for a potential customer.

2. The computing apparatus of claim 1, wherein the at least one processor is further configured to obtain the content property information by adding information semantically related to content to metadata regarding the content by using a content knowledge graph (CKG).

3. The computing apparatus of claim 2, wherein the at least one processor is further configured to compare the terminal user property information with first content property information in response to a potential customer search request related to a first content to search for a potential customer related to the first content.

4. The computing apparatus of claim 3, wherein the data received from the terminal comprises at least one of terminal identification information, terminal use history information, consumed-content information, or information about at least one electronic device connected to the terminal.

5. The computing apparatus of claim 4, wherein the terminal use history information comprises at least one of a use frequency, a use duration, a use time, or a use day of the terminal, and
the consumed-content information comprises at least one of identification information of content consumed using the terminal or consumption type information of the consumed content.

6. The computing apparatus of claim 4, wherein the information about the at least one electronic device connected to the terminal comprises at least one of device identification information, device use history information, or device use pattern information, and
wherein the at least one processor is further configured to obtain a device graph based on the information about the at least one electronic device.

7. The computing apparatus of claim 6, wherein the knowledge graph comprises at least one of a user knowledge graph (UKG) or a content knowledge graph (CKG), and
wherein the at least one processor is further configured to obtain the terminal user property information based on the data received from the terminal, the device graph, and the knowledge graph.

8. The computing apparatus of claim 7, wherein the at least one processor is further configured to:
obtain at least one of demographic information, geographical position information, use time information, a terminal use tendency, a viewing tendency, or behavior information of a terminal user; and
obtain the terminal user property information from the obtained at least one of the demographic information, the geographical position information, the use time information, the terminal use tendency, the viewing tendency, or the behavior information of the terminal user.

9. The computing apparatus of claim 7, wherein the at least one processor is further configured to, by using the CKG, obtain the terminal user property information by adding information semantically related to content consumed using the terminal to metadata regarding the consumed content.

10. The computing apparatus of claim 7, wherein the at least one processor is further configured to reinforce the terminal user property information by using the device graph.

11. An operating method of a computing apparatus, the operating method comprising:
obtaining terminal user property information based on data received from a terminal and a knowledge graph;
obtaining content property information; and
comparing the terminal user property information with content property information to search for a potential customer.

12. The operating method of claim 11, wherein the obtaining of the content property information comprises obtaining the content property information by adding information semantically related to content to metadata regarding the content by using a content knowledge graph (CKG).

13. The operating method of claim 12, wherein the searching for the potential customer comprises comparing the terminal user property information with first content property information in response to a potential customer search request related to a first content to search for a potential customer related to the first content.

14. The operating method of claim 13, wherein the data received from the terminal comprises at least one of terminal identification information, terminal use history information, consumed-content information, or information about at least one electronic device connected to the terminal.

15. The operating method of claim 14, wherein the terminal use history information comprises at least one of a use frequency, a use duration, a use time, or a use day of the terminal, and
the consumed-content information comprises at least one of identification information of content consumed using the terminal or consumption type information of the consumed content.

16. The operating method of claim 14, wherein the information about the at least one electronic device connected to the terminal comprises at least one of device identification information, device use history information, or device use pattern information, and
wherein the operating method further comprises obtaining a device graph based on the information about the at least one electronic device.

17. The operating method of claim 16, wherein the knowledge graph comprises at least one of a user knowledge graph (UKG) or a content knowledge graph (CKG), and
wherein the obtaining of the terminal user property information comprises obtaining the terminal user property information based on the data received from the terminal, the device graph, and the knowledge graph.

18. The operating method of claim 17, wherein the obtaining of the terminal user property information comprises:
obtaining at least one of demographic information, geographical position information, use time information, a terminal use tendency, a viewing tendency, or behavior information of a terminal user; and
obtaining the terminal user property information from the obtained at least one of the demographic information, the geographical position information, the use time information, the terminal use tendency, the viewing tendency, or the behavior information of the terminal user.

19. The operating method of claim 17, wherein the obtaining of the terminal user property information comprises obtaining, by using the CKG, the terminal user property information by adding information semantically related to content consumed using the terminal to metadata regarding the consumed content.

20. A non-transitory computer-readable recording medium having recorded thereon a program for executing an operating method of a computing apparatus, the operating method comprising:
obtaining terminal user property information based on data received from a terminal and a knowledge graph;
obtaining content property information; and
comparing the terminal user property information with content property information to search for a potential customer.
